(19) United States
(12) Patent Application Publication
(10) Pub. No.: US 2023/0196483 A1
(43) Pub. Date: Jun. 22, 2023

(54) METHODS AND SYSTEMS FOR MONITORING AND VERIFYING CONSTRUCTION OF SOLAR AND ENERGY STORAGE PROJECTS

(71) Applicant: TuskWare, Inc., San Rafael, CA (US)

(72) Inventors: Thomas Enzendorfer, San Anselmo, CA (US); Wai Lo, Palo Alto, CA (US)

(21) Appl. No.: 17/558,984

(22) Filed: Dec. 22, 2021

(51) Int. Cl. G06Q 50/08; G06Q 10/06; G06V 20/13; G06V 20/10; G06T 7/00; H04N 7/18

(52) U.S. Cl. CPC G06Q 50/08; G06Q 10/06313; G06Q 10/06375; G06T 7/001; G06V 20/13; G06V 20/176; H04N 7/183; G06T 2207/10032

(57) ABSTRACT

A method of monitoring and verifying construction and commissioning of solar and energy storage projects comprising: providing a central device; providing a satellite device, which comprises a digital camera; prompting a user to take a digital photograph of part of a solar and energy storage project; transmitting the digital photograph to the central device determining by the central device whether the digital photograph shows that the solar and energy storage project has been constructed and commissioned correctly; and generating impact forecasts and work instructions if constructed and commissioned incorrectly or generating a project completed message if constructed correctly. The work instructions may prompt the user to retake the photo and do the process again. At project completion, update the information of equipment, image processing and classification algorithms, impact forecasts, work instruction sets and work flows in the central and satellite devices for improving the verification accuracy of future projects.

### FIELD OF DISCLOSURE

The present disclosure relates to methods and systems for monitoring and verifying construction of solar and energy storage projects. More specifically, the present disclosure relates to automatically determining whether the construction of a solar energy project and/or an energy storage project is being completed correctly.

### BACKGROUND

The solar energy field is growing rapidly, which includes the construction of thousands of solar energy projects. In order to maximize efficiency of construction, the construction industry verifies progress though photo documentation of the work progress. This ensures that the work completed is correct and the next stage of construction can be undertaken. Typically, the photo documentation and verification of work progress requires that photos of the ongoing work are taken and then reviewed by human supervisors and managers for accuracy and quality control purposes. This process is deficient because the picture may be insufficient, but this is only recognized after the human reviews it. The process is also deficient because errors in construction are not noticed until after the picture is reviewed by a human.

Thus, what is needed is a system for automating the picture documentation and work verification process. The system preferably automatically and virtually instantaneously recognizes if the photos taken reflect the required task and then prompts the taking of a new picture or suggesting a correction to be made to the work product. This system may have applications in other fields, such as washing hands as required, donning personal protective equipment, or completing other construction projects not related to solar energy. This may also be applied to recognizing the need for maintenance or predicting how long before there is a structural failure.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a dynamic supervisory system for solar and energy storage projects.

One embodiment may be a method of monitoring and verifying construction of solar and energy storage projects and may comprise: providing a central device; providing one or more satellite devices, each of which comprises a digital camera and a communication devices module; wherein said central device and said one or more satellite devices are in communication with each other; entering, by a project owner, into said one or more satellite devices a project type, one or more project goals, a plurality of project information, a plurality of equipment information, and one or more action recommendations; inputting to said one or more satellite devices an object information capture; transmitting, by said one or more satellite devices, said object information capture to said central device; extracting one or more features, by said central device, from said object information capture; determining, by said central device, a plurality of measurements of said extracted features; comparing, by said central device, said plurality of measurements of said extracted features to at least one specification of project goal of said one or more project goals; determining, by said central device, whether said at least one specification is deficient; generating one or more work instructions and one or more impact forecasts if said at least one specification are deficient and transmitting said one or more impact forecasts and said one or more work instructions to said one or more satellite devices; generating a project completed message and a completed project data if said at least one specification is determined to be acceptable after comparison with said one or more project goals; and updating, by said central device, said plurality of project information, said plurality of equipment information, and said one or more action recommendations with said completed project data.

The method of monitoring and verifying construction of solar and energy storage may comprise: transmitting, by said one or more satellite devices, said project type, said one or more project goals, said plurality of project information, said plurality of equipment information, and said one or more action recommendations to said central device; generating, by said central device, an information capture instruction based on said project type, said one or more project goals, said plurality of project information, said plurality of equipment information, and said one or more action recommendations; and receiving, by said one or more satellite devices, said information capture instruction. The method of monitoring and verifying construction of solar and energy storage projects may further comprise: providing, by said one or more satellite devices, said information capture instruction to said project owner. The method of monitoring and verifying construction of solar and energy storage projects may further comprise: processing, by said central device, said project completed message; transmitting said project completed message to said one or more satellite devices; and outputting, by said one or more satellite devices, said project completed message. The method of monitoring and verifying construction of solar and energy storage projects may further comprise: classifying and preprocessing, by said one or more satellite devices, said object information capture before said object information capture is transmitted to said central device; and final processing, by said central device, said classified and preprocessed object information capture before said one or more features are extracted. The method of monitoring and verifying construction of solar and energy storage projects may further comprise: outputting, by said one or more satellite devices, said one or more work instructions to said project owner.

The method of monitoring and verifying construction of solar and energy storage projects of may comprise: providing a plurality of project objects at a project site; and completing, by said project owner, said one or more work instructions on said project objects. The method of monitoring and verifying construction of solar and energy storage projects may further comprise: wherein said one or more work instructions comprise a second information capture instruction, such that a second object information capture is inputted into said one or more satellite devices after said one or more work instructions are completed. The central device may comprise a server device and one or more edge devices; and wherein at least one of said one or more edge devices is located at said project site. The object information capture may be configured to be a digital photograph. The method of monitoring and verifying construction of solar and energy storage projects may further comprise: transmitting said project completed message to a project owner system.

The method of monitoring and verifying construction of solar and energy storage projects may further comprise: storing, by said central device, said information capture instruction; storing, by said one or more satellite devices, said information capture instruction; storing, by said central device, said classified and preprocessed object information capture; storing, by said central device, said final processed object information capture; storing, by said central device, said extracted features; storing, by said central device, said at least one specification of said extracted features; storing, by said one or more satellite devices, said one or more work instructions; and storing, by said central device, said completed project data. The project type may be an installation of a solar energy project. The project type may be an installation of an energy storage project.

Another embodiment may be a method of monitoring and verifying construction of solar and energy storage projects that may comprise: providing a central device; providing a satellite device, which comprises a digital camera and a communication devices module; wherein said central device and said satellite device are in communication with each other; entering, by a project owner, into said satellite device a project type, one or more project goals, a plurality of project information, a plurality of equipment information, and one or more action recommendations; transmitting, by said satellite device, said project type, said one or more project goals, said plurality of project information, said plurality of equipment information, and said one or more action recommendations to said central device; generating, by said central device, an information capture instruction based on said project type, said one or more project goals, said plurality of project information, said plurality of equipment information, and said one or more action recommendations; and receiving, by said satellite device, said information capture instruction; providing, by said satellite device, said information capture instruction to said project owner; wherein said information capture instruction is to take a first digital photograph inputting to said satellite device an object information capture; wherein said object information capture is said first digital photograph; transmitting, by said satellite device, said digital photograph to said central device; extracting one or more features, by said central device, from said digital photograph; determining, by said central device, a plurality of specifications of said extracted features; comparing, by said central device, said plurality of specifications of said extracted features to at least one project goal of said one or more project goals; determining, by said central device whether said plurality of specifications are deficient; generating one or more work instructions and one or more impact forecasts if said plurality of specifications are deficient and transmitting said one or more impact forecasts and said one or more work instructions to said satellite device; and generating a project completed message and a completed project data if said plurality of specifications are determined to be acceptable after comparison with said at least one project goal.

The method of monitoring and verifying construction of solar and energy storage projects may further comprise: outputting, by said satellite device, said one or more work instructions to said project owner; and completing, by said project owner, said one or more work instructions on one or more project objects; and wherein said one or more work instructions comprise taking a second digital photograph, such that a second digital photograph is inputted into said satellite device. The method of monitoring and verifying construction of solar and energy storage projects may further comprise: processing, by said central device, said project completed message; transmitting, by said central device, said project completed message to said satellite device; outputting, by said satellite device, said project completed message; and updating, by said central device, said plurality of project information, said plurality of equipment information, and said one or more action recommendations with said completed project data.

Another embodiment may be a method of monitoring and verifying construction of solar and energy storage projects that may comprise: providing a central device; providing a satellite device, which comprises a digital camera and a communication devices module; wherein said central device and said satellite device are in communication with each other; prompting a user to take a digital photograph of at least a portion of a solar and energy storage project with said satellite device; taking said digital photograph with said satellite device; transmitting said digital photograph to said central device; determining by said central device whether said digital photograph shows that said at least a portion of a solar and energy storage project has been constructed correctly; generating one or more work instructions and one or more impact forecasts if constructed incorrectly; transmitting said one or more impact forecasts and said one or more work instructions to said satellite device; and generating a project completed message and a completed project data if constructed correctly. The one or more work instructions may comprise prompting said user to take a second digital photograph of said at least a portion of said solar and energy storage project with said satellite device after said one or more work instructions are completed.

Another embodiment may be a method of monitoring and verifying construction of solar and energy storage projects that may comprise: providing a central device; providing one or more satellite devices, each of which comprises a digital camera and a communication devices module; providing a plurality of project objects at a project site; wherein said central device comprises a server device and one or more edge devices; wherein said central device and said one or more satellite devices are in communication with each other; entering, by a project owner, into said one or more satellite devices a project type, one or more project goals, a plurality of project information, a plurality of equipment information, and one or more action recommendations; transmitting, by said one or more satellite devices, said project type, said one or more project goals, said plurality of project information, said plurality of equipment information, and said one or more action recommendations to said central device; generating, by said central device, an information capture instruction based on said project type, said one or more project goals, said plurality of project information, said plurality of equipment information, and said one or more action recommendations; and storing, by said central device, said information capture instruction; receiving, by said one or more satellite devices, said information capture instruction; storing, by said one or more satellite devices, said information capture instruction; providing, by said one or more satellite devices, said information capture instruction to said project owner; inputting to said one or more satellite devices an object information capture; wherein said object information capture is a digital photograph; classifying, by said one or more satellite devices, said object information capture; preprocessing, by said one or more satellite devices, said object information capture; transmitting, by said one or more satellite devices, said classified and preprocessed object information capture to said central device; storing, by said central device, said classified and preprocessed object information capture; final processing, by said central device, said classified and preprocessed object information capture; storing, by said central device, said final processed object information capture; extracting one or more features, by said central device, from said final processed object information capture; storing, by said central device, said extracted features; determining, by said central device, a plurality of specifications of said extracted features; storing, by said central device, said plurality of specifications of said extracted features; comparing, by said central device, said plurality of specifications of said extracted features to a project goal; determining, by said central device, whether said plurality of specifications are deficient; generating one or more work instructions and one or more impact forecasts if said plurality of specifications are deficient and transmitting said one or more impact forecasts and said one or more work instructions to said one or more satellite devices; storing, by said one or more satellite devices, said one or more work instructions; outputting, by said one or more satellite devices, said one or more work instructions to said project owner; completing, by said project owner, said one or more work instructions on said project objects; wherein said one or more work instructions comprise a second information capture instruction, such that a second object information capture is inputted into said one or more satellite devices after said one or more work instructions are completed; generating a project completed message and a completed project data if said plurality of specifications are determined to be acceptable after comparison with said project goal; processing, by said central device, said project completed message; transmitting said project completed message to said one or more satellite devices; transmitting said project completed message to a project owner system; outputting, by said one or more satellite devices, said project completed message; storing, by said central device, a completed project data; and updating, by said central device, said plurality of project information, said plurality of equipment information, and said one or more action recommendations with said completed project data.

In some embodiments, the system and method of the present disclosure may use computer vision to determine whether a picture (photograph or digital) reflects completion of a required task and prompting the user to retake a picture of correct work product in response to the determination. In particular, the system and method may extract features or objects from an image in order to determine whether the features or objects meet pre-defined criteria. The system can derive desired status changes based on whether the features meet the pre-defined criteria. The system, in some embodiments may also include recognizing maintenance requirements and possible failures based on the original picture. The system may also include text recognition and decisional logic to determine corrective instructions in the form on text, rather than only pass/fail feedback.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow block diagram showing another embodiment of the methods and systems of the present disclosure.

FIG. 2 is an illustration of one embodiment of a satellite device of the present disclosure.

FIG. 3 is an illustration of one embodiment of a central device of the present disclosure.

FIG. 4 is a flow block diagram showing one embodiment of the methods and systems of the present disclosure.

FIG. 5 is a flow block diagram showing another embodiment of the methods and systems of the present disclosure.

FIG. 6 is a flow block diagram showing one embodiment of the methods and systems of the present disclosure showing the interactions between the central device and the satellite device.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, electric charge storage device or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer- readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “project owner” may refer to an individual or company, including, but not limited to, a property owner, installer, maintenance technician, contractor, device sign-in information, and/or engineer.

As used herein, the term “project type” may refer to any facet of a solar energy and/or energy storage project, including, but not limited to, installation, commissioning, inspection, maintenance and related services, warranty services, repairs and replacements, product validation, product development, training, demonstrations, sign-off, applications (use case setting, and the like), and/or fraud detection.

As used herein, the term “project goals” may refer to a goal of a solar energy and/or energy storage project, including, but not limited to, completion of the project, completion of the sign-off, impact assessment, and/or fraud detection.

As used herein, the term “project information” may include, but not be limited to: property owner information (name, address, email, phone number, site map, and the like); system design information (single line diagram (SLD), drawings, equipment list, equipment serial numbers, and the like); permit information (authority having jurisdiction (AHJ), contact persons, documentation, and the like); process information (flows for inspection, installation, commissioning, sign-off, fraud detection, training/demo, repair/replace, validation, maintenance, warranty services, product development, and the like); and/or acceptance criteria.

As used herein, the term “equipment information” may include, but not be limited to: product information (pictures, make, model, specifications, certifications, final test results, and the like); software information (versions, test results, and the like); quality information (production date, batch, alarm messages, frequent failure modules, frequent root causes, and the like); performance information (monitoring data, alarms, and the like); operations and maintenance (O&M) information (firmware update records, maintenance records, repair/replacement records, setting records, environmental records, and the like); and/or acceptance specifications (status indicators, parameters, system performance, and the like).

As used herein, the terms “impact forecast” and/or “action recommendations” may include, but not be limited to: action history; equipment performance forecast models (based on equipment information, project information, and the like); impact forecast models (on components, system performance, fraud, warranty, sign-off, usage, and the like); work instructions (install, replace, repair, commission, validate, and the like); information capture instructions (picture, video, object to capture, and the like; and/or flow instruction (such as next steps).

As used herein, the term “information capture” may include, but not be limited to, pictures, videos, texts, time stamps and GPS information, signals, documents, drawings, one or more of the project types, one or more of the project owners, one or more of the project information, action recommendations, and/or equipment information.

As used herein, the term “work actions” may include, but not be limited to, sign-in information; install, replace, repair, commission, validate, flow step, and the like.

As used herein, the term “project objects” may refer to anything related to a solar energy and/or energy storage project, including, but not limited to: photovoltaic (PV) system components (PV panel, racking, splice, end cap, roof penetration, roof clearance, sealing, flashing, cable, cable management, inter-connection, inverter, micro-inverter, optimizer, transformer, auto-transformer switch, meter, current transformer (CT), rapid shut down transmitter, rapid shut down receiver, displays screen, combiner box, circuit breaker, junction box, fuse, main panel, gateway, antenna, modem, monitoring portal display, labels, and the like); energy storage system components (battery, battery management systems (BMS), display screen, wires, critical load panel, and the like); site features (roof top, attic, rafter size, rafter span, rafter spacing, leaks, side wall, ground, trench, wiring, conduits, and the like); safety equipment (personal protective equipment (PPE), masks, gloves, face shields, arc fault face guard, signs, ladder, hand sanitizer, fall protection, and the like); and/or documentation (check list, system design, permit document, and the like).

As used herein, the term “information processing” may refer to any facet of a solar energy and/or energy storage project, including, but not limited to, image processing, text extraction, feature extraction, information classification, impact forecast refining (based on processed information, equipment information, equipment performance forecast models, impact forecast models, and the like), and/or information comparison (with acceptance criteria, project goals, and the like).

As used herein, the term “solar and energy storage projects” may refer to the construction, repair, review, and the like, of a solar energy project, an energy storage project, or both.

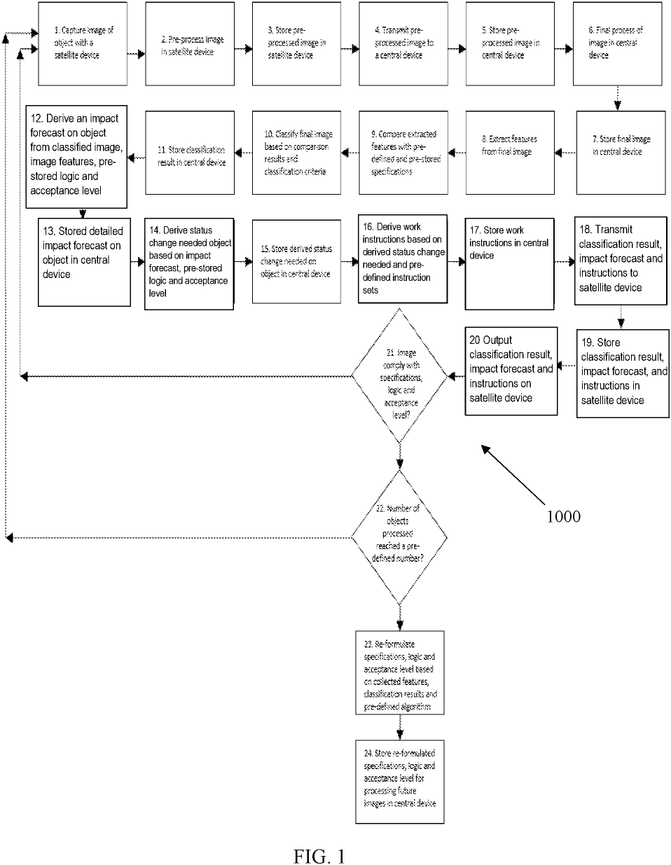

FIG. 1 is a flow block diagram showing another embodiment of the methods and systems of the present disclosure. As shown in FIG. 1, the method 1000 may comprise the steps: capturing an image of an object or installation 1; pre-processing the image in a satellite device 2; storing the pre-processed image in the satellite device 3; transmitting (wired or wirelessly), by the satellite device, the pre-processed image to a central device 4; storing the pre-processed image in the central device 5; processing the image by the central device 6; storing the final image in the central device 7; extracting features from the final image 8; comparing the extracted features with pre-defined and pre-stored specifications 9; classifying the final image based on comparison results and classification criteria 10; storing classification results in the central device 11; deriving impact forecast on the object/installation from the classified image, the image features, pre-stored logic, and acceptance level 12; storing the derived impact forecast about the object in the central device 13; deriving a status change needed on the object based on inferences, pre-stored logic, and an acceptance level 14; storing the derived status change needed on the object in the central device 15; deriving instructions based on the derived status change needed and pre-defined instruction sets 16; storing the work instructions in the central device 17; transmitting the classification result, impact forecast, and instructions to the satellite device 18; storing the classification result; impact forecast; and instructions in the satellite device 19; outputting on the satellite device the classification results and instructions 20; if the image complies with the specifications, logic, and has a reached the threshold acceptance level, then image is approved and/or stored 21; if the objects being processed are installed correctly 22, then the installation is approved; if the image does not comply or if the installation is not done correctly, the installation is corrected and/or another image is captured, such as by capturing an image of an object or installation 1, and the process steps 2-11 are repeated; reformulating the specifications, logic, and acceptance level based on the collected features, the classification results, and/or a pre-defined algorithm 23; and storing, in the central device, the reformulated specifications, logic, and acceptance level for processing future images 24.

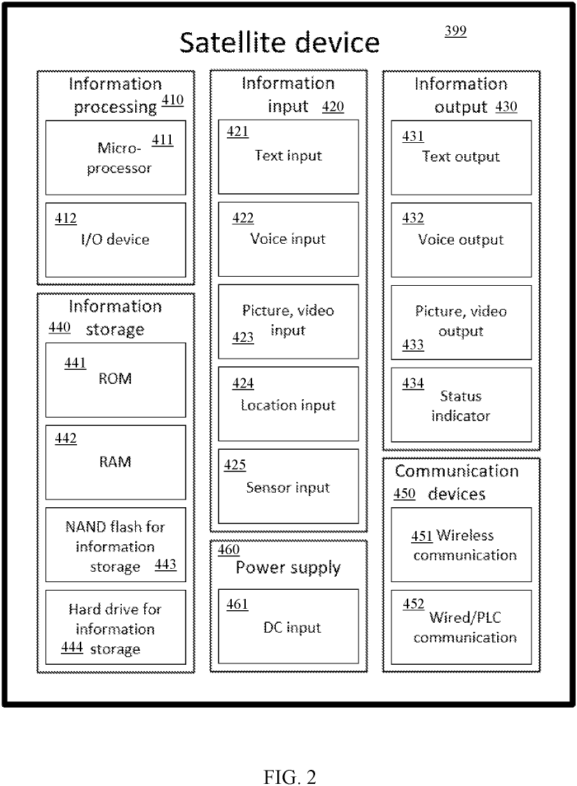

FIG. 2 is an illustration of one embodiment of a satellite device of the present disclosure. FIG. 2 shows that the satellite device 399 may comprise an information processing module 410, an information input module 420, an information output module 430, an information storage module 440, communication devices module 450, and power supply 460. The satellite device 399 may be a smart phone, tablet, laptop computer, desktop computer, or any electronic data processing unit with input, output, and connectivity modules. In some embodiments, the satellite device 399 may be a purpose-built device. The satellite device may be used by the project owner at the job or installation site.

The information processing module 410 may comprise a microprocessor 411 and may be used to process information obtained from a project owner, a project object, and/or an edge device. An edge device may be, in basic terms, a device that allows the movement of some portion of storage and computer resources out of a central data center and closer to the source of the data itself. Rather than transmitting raw data to a central data center for processing and analysis, that work may instead be performed where the data is physically generated. Typically, only the result of that computing work at the edge, such as equipment maintenance predictions or other actionable answers, is sent back to the main data center for review and other human interactions. In various embodiments, the information processing module 410 comprises an I/O device/sub-module (input and output device). Non-limiting examples of an I/O device may be one or more of, data latch, data register, clock, I/O bus, power devices. In some embodiments, it may also be one or more of, CD-R/RW, DVD, Blu-ray drive, digital camera, fax machine, floppy diskette drive, hard drives, modem, NIC (network interface card), SD (secure digital) card, sound card, touch screen, mouse, keyboard, USB flash drive and ports, and the like.

The information input module 420 may comprise a text input 421, voice input 422, picture and/or video input 423, location input 424, and/or sensor input 425. The information input module 420 may be for accepting input from the project owner and/or the project objects. The information input module 420 preferably may accept one or more of incoming video, text, audio, sensor, and/or GPS or location input. The picture and/or video input 423 may be a digital camera.

The information output module 430 may comprise a text output 431, voice output 432, picture and/or video output 433, and/or status indicator 434. The information output module 430 may provide output information to the project owner and the project owner system and preferably outputs one or more of video, text, audio, sensor, and/or location signals.

The information storage module 440 may comprise ROM (read only memory) 441, RAM (random access memory) 442, NAND (Not AND Boolean logic operation) flash for information storage 443, and/or hard drive 444 for information storage. The information storage module 440 may provide for storing information obtained from the project owner, project object, edge device, and processed information by the satellite device 339.

The communication devices module 450 may comprise a wireless communication 451 and/or wired / power line communication (PLC) 452. The communication devices module 450 may provide for exchanging information with an edge device and/or the project owner system. Preferably, the satellite device 399 may communicate wired or wirelessly with the other devices of the system and with third-party devices.

The power supply 460 may comprise a direct current (DC) input 461. The power supply 460 may power the operation of the satellite device 399 and may be battery or converted AC power.

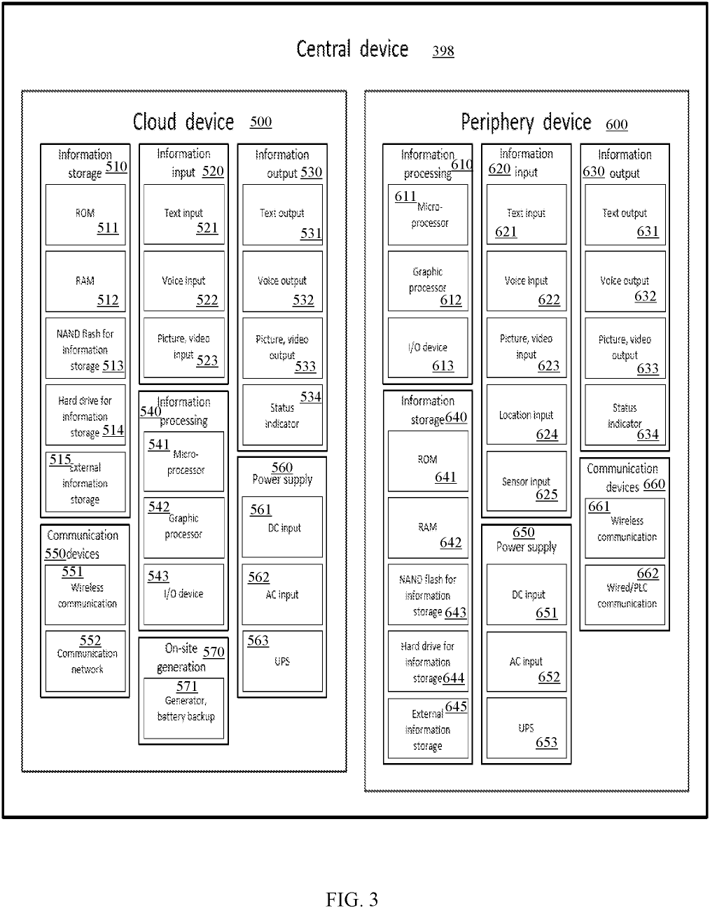

FIG. 3 is an illustration of one embodiment of a central device of the present disclosure. FIG. 3 shows that the central device 398 may comprise a cloud (or server) device 500 and periphery (or edge) device 600. Although the central device 398 is shown in FIG. 3 as comprising a server and one or more edge devices, the central device 398 may be a single cloud or server device. The server device 500 may comprise an information storage module 510, information input module 520, information output module 530, communication devices module 550, and power supply 560. Preferably, the edge device 600 may be connected to the server device 500 through networks and may be used by the project owner for providing support to the satellite devices. The server device 500 may be connected to multiple edge devices through networks and may be used to support the multiple edge devices.

The server device 500 information storage module 510 may comprise one or more of ROM 511, RAM 512, NAND flash for information storage 513, hard drive for information storage 514, and/or external information storage 515. The information storage module 510 may be used for storing information obtained from the one or more edge devices 600 and information processed by server device 500.

The information input module 520 may comprise one or more of text input 521, voice input 522, and picture and/or video input 523. The information input module 520 may be used for accepting input from the edge devices.

The information output module 530 may comprise one or more of text output 531, voice output 532, picture and/or video output 533, and status indicator 534. The information output module 530 may be for providing output information to the edge devices.

The information processing module 540 may comprise a micro-processor 541, graphic processor 542, and I/O device 543. The information processing module 540 may process information obtained from the edge devices.

The communication devices module 550 may comprise a wireless communication system 551 and a communication network 552. The communication devices module 550 may be used for exchanging information with the edge devices and may communicate wired or wirelessly.

The power supply 560 may comprise a DC input 561, alternating current (AC) input 562, and uninterrupted power supply (UPS) 563. The power supply 560 may provide power to the server device 500.

The on-site generation 570 may comprise a generator and/or a battery backup 571.

The information processing module 610 of the edge device 600 may comprise a micro-processor 611, a graphic processor 612, and I/O device 613. The information processing module 610 may process information received from server device 500 and satellite devices 399.

The information input module 620 may comprise one or more of text input 621, voice input 622, picture and/or video input 623, location input 624, and sensor input 625. The information input module 620 may receive input from the server device 500 and satellite devices 399.

The information output module 630 may comprise text output 631, voice output 632, picture and/or video output 633, and status indicator 634. The information output module 630 may provide output information to the server device 500, satellite devices 399, and to the project owner systems.

The power supply 650 may comprise DC input 651, AC input 652, and/or UPS 653. The power supply 650 may provide power to the edge devices, which may preferably be onsite to and/or part of the solar power and/or energy storage project.

The communication device module 660 may comprise a wireless communication system 661 and wired/PLC communication system 662. The communication device module may exchange information with the server device 500, satellite devices 399, and to the project owner systems. The communication may be wired or wireless.

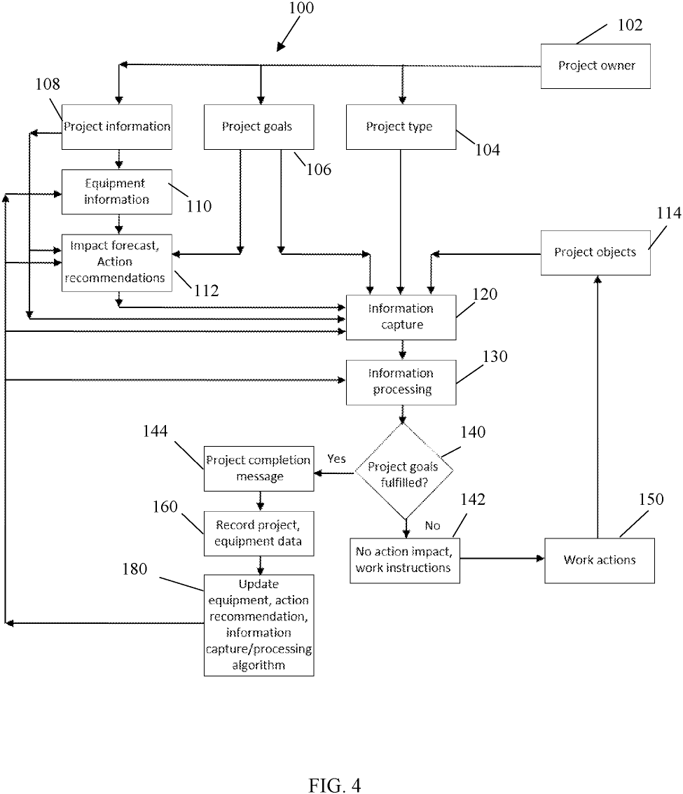

FIG. 4 is a flow block diagram showing one embodiment of the methods and systems of the present disclosure. FIG. 4 shows one embodiment of the dynamic supervisory system 100 for solar and energy storage projects. The project owner 102 may set and provide the parameters of the project, such as the project type 104 and project goals 106. The project owner 102 may also be responsible for uploading or entering the project information 108, the equipment information 110, impact forecasts and/or action recommendations 112. The equipment information 110 and impact forecast and/or action recommendations 112 may be updated as needed by the project owner 102 or may be updated automatically based on the completion progress of the installation and the processing, approving, and rejection of the captured images. Based on the action history, equipment performance forecast models, impact forecast models, work instructions, information capture instructions, and flow instructions, the impact forecast and action recommendations 112 may be determined by and/or provided to the dynamic supervisory system 100. The project objects 114 are loaded into the dynamic supervisory system 100 and may be the subject of the information capture 120. The information capture 120 may be an image capture of one of the project objects 114 of the installation. The information/image may then be processed 130 by the central device 398, in accordance, for example, with the method shown in FIG. 1. The dynamic supervisory system 100 may determine whether the project goal being reviewed for completion in the captured image has been fulfilled 140. If it has not, there may be no action impact and work instructions 142 may be generated and shown to the user on a satellite device. The work actions 150 may be to retake the picture / re-capture the information, or it may be to complete the project objects 114 that was the basis of the project goal 106 in the first place. The user may then start over at information capture 120. If it is determined that the project goals 106 of the project objects 114 have been fulfilled, a project completed message 114 may be generated. The project and equipment updates and data may be recorded and saved 160. The dynamic supervisory system 100 may then be updated, including, but not limited to, the equipment information 110, action recommendations 112, information capture 120, and information processing 130. In this manner, the systems specifications and parameters may be updated, and the completion of the project goal may be taken into consideration with respect to the next project goal and the processing of the next information capture.

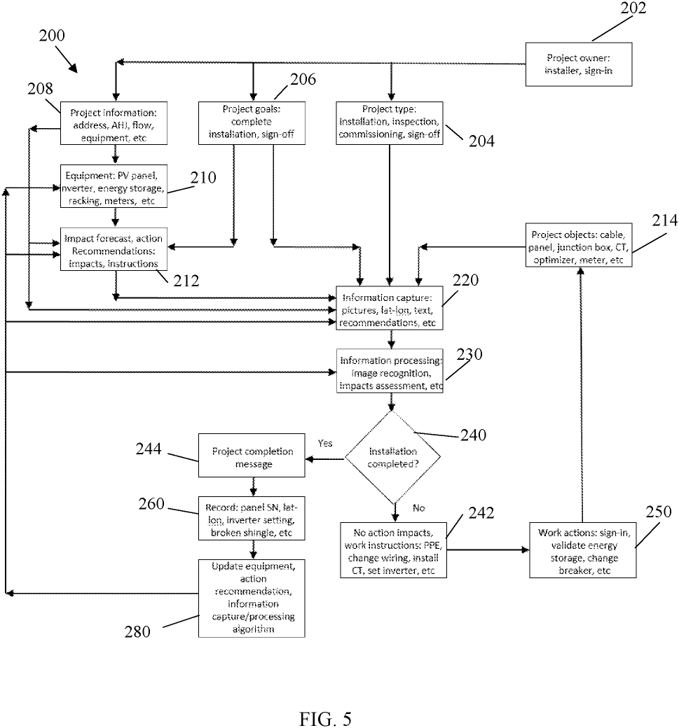

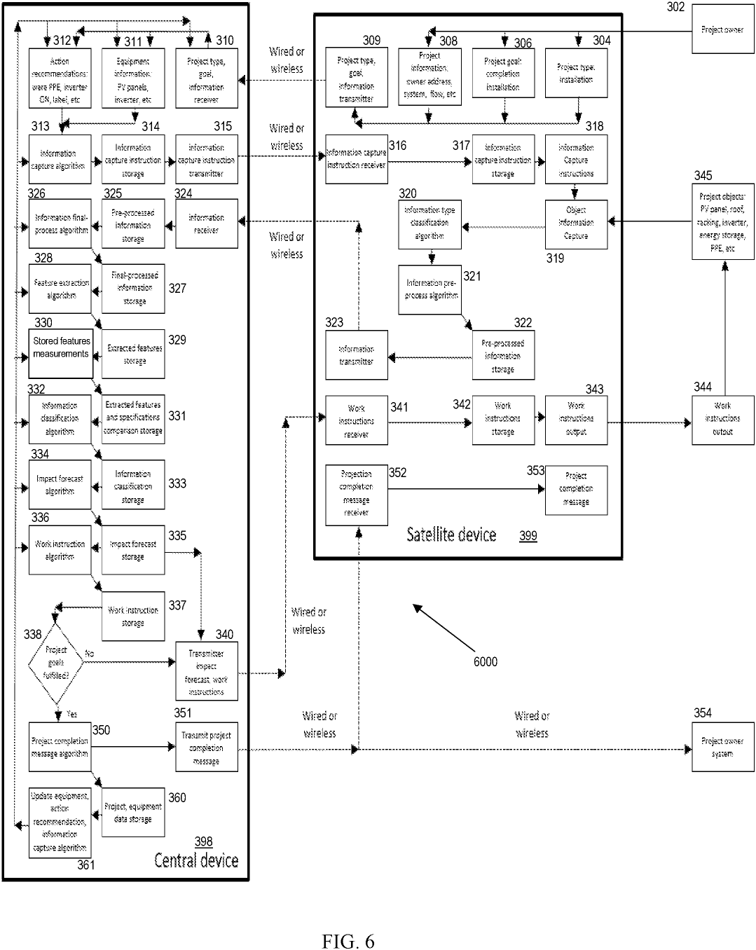

FIG. 5 is a flow block diagram showing another embodiment of the methods and systems of the present disclosure. FIG. 5 shows one embodiment of an application of the dynamic supervisory system on a solar and energy storage installation project 200. As shown, the project owner 202, which may the project installer, may sign-in to the project 200 and provide or update the (1) project type 204, which may be an installation, an inspection, a commissioning, repair, or a final sign-off; (2) the project goals 206, which may be completion of the installation through a series of steps that are each signed-off as they are completed; (3) project information 208, such as address, jurisdiction, construction flow, equipment, and the like; (4) equipment 210, which may be any device related to the construction of the solar energy and/or energy storage project; (5) impact forecasts / action recommendations 212, which may include instructions on what to do when a project goal is not completed correctly; and/or (6) project objects 214, which may be any part of the installation project that is constructed, repaired, or completed during the installation or other project type. The system requires the user at the installation site to take a picture or otherwise capture information related to the project 220. This may be a picture/photo, global positioning system (GPS) information, text, recommendations, and the like. The captured information may be processed 230, for example in the flow shown in FIG. 6. The information processing 230 may comprise image recognition, impact assessments, and the like. The system may determine whether the project goal is met, such as whether the installation is completed 240. If the project goal is not met, or if a new image capture is required, the system may issue work instructions 242. No action impact is generated, and the user may be directed to retake the picture or complete the project goal correctly. The user may take work actions 250 and update the project objects 214. If the system determines that the project was installed correctly and the goals are met, a project completed message 244 may be generated and recorded 260. The system preferably updates, automatically, the equipment, action recommendations, and the information capture / processing algorithm 280.

FIG. 6 is a flow block diagram showing one embodiment of the methods and systems of the present disclosure showing the interactions between the central device and the satellite device. As shown in FIG. 6, the system 6000 shows that the project owner may access and sign into the satellite device 399 and provide and/or update the: (1) project type 304, which in FIG. 6 may be an installation of a solar power system and/or an installation of an energy storage system; (2) project goal 306, which may be completion of the installation; (3) project information 308, which may be owner address, information related to every facet of the project/installation, the sub-completion steps, the order in which the steps much be completed, the acceptable criteria for completion, the construction equipment needed, the raw materials needed, site location information, logistics, and the like. The raw materials needed to complete the project may be part of the project objects, and may comprise photovoltaic panels (PV panels), roof, racking, inverters, energy storage devices, personal protective equipment, PPE, and the like. The project type 304, project goal 306, and project information 308 may be stored in the satellite device 399 and be transmitted by the transmitter 309, wired or wirelessly, to the central device 398 receiver 310. The central device 398 may be comprised of a server device 500 and a periphery or edge device 600, as shown in FIG. 3. The information received by the receiver 310 may include equipment information 311 and action recommendations 312. The action recommendations 312 may be tailored to call out specific deficiencies in the completion of the specific project, such as wrong equipment installed, equipment installed incorrectly, location incorrect, label deficiencies, safety equipment deficiencies, and the like. The system 6000 may update the information capture algorithm 313 with the action recommendations 312 and equipment information 311. The information capture algorithm may generate an information capture instruction, which may be stored 314 and transmitted 315 (wired or wirelessly) to the satellite device 399, which may receive 316 the information capture instructions. The information capture instructions may be stored 317 and provided 318 to the project owner 302. The project owner may capture the information 319, such as positioning the satellite device 399 in proximity to the project objects and taking a photo of the completed project step or completed project. The information captured may be processed by the information type classification algorithm 320 and the information pre-process algorithm 321. The pre-processed and classified information may be stored 322 on the satellite device 399 and transmitted 323 to the central device 398 receiver 324. The pre-processed information may be stored 325 on the central device 398. The information final-process algorithm 326, such as image re-sizing, brightness adjustment, normalization, and the like, may then process the pre-processed information (the photo taken) to generate a final-processed information. The final-processed information may be stored 327 and then processed by the feature extraction algorithm 328 based on pre-defined features, such as color, shape, equipment labels, and the like. The extracted features to be analyzed may be stored 329 and their measurements, such as dimensions, determined 330 for comparison purposes. The extracted features and measurements to be compared may be stored 331 and passed to the information classification algorithm 332 based on specifications such as content of extracted text, type of object, object dimensions, and the like, for a determination of the classification of the information. The information classification may be stored 333 and then passed to the impact forecast algorithm 334 to generate an impact forecast, such as fire hazard if there grounding mis-wiring, over-discharge risk issue if battery is not set up properly, and the like. The impact forecast may be stored 335 and passed to the work instruction algorithm 336, which may generate a work instruction, if needed. The work instruction may be stored 337. The impact forecast may also be transmitted 340 to the satellite device. If the project goal fulfillment 338 is negative, the impact forecast and work instructions may be transmitted 340 to the satellite device 399 and received 341. The work instructions may be stored 342 and then outputted 343 to the project owner 344 so that fixes may be made to the project objects 345. When the project goal is fulfilled 338, the project completion message algorithm 350 may generate a project completed message, which may be transmitted 351 to the satellite device 399 receiver 352 and to the project owner’s system 354. The project completed message 353 may be conveyed to the project owner, confirming that the project goal was fulfilled. The system stores 360 project completed and equipment data. The system may also update 361 the equipment information 311, action recommendations 312, and information capture algorithm 313 with the project completed and equipment data. The system may also update algorithms 326, 328, 332, 334, 336 to take into consideration the fulfilled project goal, project completed data, and equipment data.

The systems and devices of the present disclosure have been presented in an illustrative style. The terminology employed throughout should be read in an exemplary rather than a limiting manner. While various exemplary embodiments have been shown and described, it should be apparent to one of ordinary skill in the art that there are many more embodiments that are within the scope of the devices and system of the present disclosure. Accordingly, the devices and systems of the present disclosure are not to be restricted, except in light of the appended claims and their equivalents.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD- ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of monitoring and verifying construction of solar and energy storage projects comprising:
providing a central device;
providing one or more satellite devices, each of which comprises a digital camera and a communication devices module;
wherein said central device and said one or more satellite devices are in communication with each other;
entering, by a project owner, into said one or more satellite devices a project type, one or more project goals, a plurality of project information, a plurality of equipment information, and one or more action recommendations;
inputting to said one or more satellite devices an object information capture;
transmitting, by said one or more satellite devices, said object information capture to said central device;
extracting one or more features, by said central device, from said object information capture;
determining, by said central device, a plurality of measurements of said extracted features;
comparing, by said central device, said plurality of measurements of said extracted features to at least one specification of project goal of said one or more project goals;
determining, by said central device, whether said at least one specification is deficient;
generating one or more work instructions and one or more impact forecasts if said at least one specification are deficient and transmitting said one or more impact forecasts and said one or more work instructions to said one or more satellite devices;
generating a project completed message and a completed project data if said at least one specification is determined to be acceptable after comparison with said one or more project goals; and
updating, by said central device, said plurality of project information, said plurality of equipment information, and said one or more action recommendations with said completed project data.

2. The method of monitoring and verifying construction of solar and energy storage projects of claim 1, further comprising:
transmitting, by said one or more satellite devices, said project type, said one or more project goals, said plurality of project information, said plurality of equipment information, and said one or more action recommendations to said central device;
generating, by said central device, an information capture instruction based on said project type, said one or more project goals, said plurality of project information, said plurality of equipment information, and said one or more action recommendations; and
receiving, by said one or more satellite devices, said information capture instruction.

3. The method of monitoring and verifying construction of solar and energy storage projects of claim 2, further comprising:
providing, by said one or more satellite devices, said information capture instruction to said project owner.

4. The method of monitoring and verifying construction of solar and energy storage projects of claim 1, further comprising:
processing, by said central device, said project completed message;
transmitting said project completed message to said one or more satellite devices; and
outputting, by said one or more satellite devices, said project completed message.

5. The method of monitoring and verifying construction of solar and energy storage projects of claim 1, further comprising:
classifying and preprocessing, by said one or more satellite devices, said object information capture before said object information capture is transmitted to said central device; and
final processing, by said central device, said classified and preprocessed object information capture before said one or more features are extracted.

6. The method of monitoring and verifying construction of solar and energy storage projects of claim 1, further comprising:
outputting, by said one or more satellite devices, said one or more work instructions to said project owner.

7. The method of monitoring and verifying construction of solar and energy storage projects of claim 6, further comprising:
providing a plurality of project objects at a project site; and
completing, by said project owner, said one or more work instructions on said project objects.

8. The method of monitoring and verifying construction of solar and energy storage projects of claim 6, further comprising:
wherein said one or more work instructions comprise a second information capture instruction, such that a second object information capture is inputted into said one or more satellite devices after said one or more work instructions are completed.

9. The method of monitoring and verifying construction of solar and energy storage projects of claim 7, wherein said central device comprises a server device and one or more edge devices; and
wherein at least one of said one or more edge devices is located at said project site.

10. The method of monitoring and verifying construction of solar and energy storage projects of claim 1, wherein said object information capture is a digital photograph.

11. The method of monitoring and verifying construction of solar and energy storage projects of claim 1, further comprising:
transmitting said project completed message to a project owner system.

12. The method of monitoring and verifying construction of solar and energy storage projects of claim 5, further comprising:
storing, by said central device, said information capture instruction;
storing, by said one or more satellite devices, said information capture instruction;
storing, by said central device, said classified and preprocessed object information capture;
storing, by said central device, said final processed object information capture;
storing, by said central device, said extracted features;
storing, by said central device, said at least one specification of said extracted features;
storing, by said one or more satellite devices, said one or more work instructions; and
storing, by said central device, said completed project data.

13. The method of monitoring and verifying construction of solar and energy storage projects of claim 1, wherein said project type is an installation of a solar energy project.

14. The method of monitoring and verifying construction of solar and energy storage projects of claim 1, wherein said project type is an installation of an energy storage project.

15. A method of monitoring and verifying construction of solar and energy storage projects comprising:
providing a central device;
providing a satellite device, which comprises a digital camera and a communication devices module;
wherein said central device and said satellite device are in communication with each other;
entering, by a project owner, into said satellite device a project type, one or more project goals, a plurality of project information, a plurality of equipment information, and one or more action recommendations;
transmitting, by said satellite device, said project type, said one or more project goals, said plurality of project information, said plurality of equipment information, and said one or more action recommendations to said central device;
generating, by said central device, an information capture instruction based on said project type, said one or more project goals, said plurality of project information, said plurality of equipment information, and said one or more action recommendations; and
receiving, by said satellite device, said information capture instruction;
providing, by said satellite device, said information capture instruction to said project owner;
wherein said information capture instruction is to take a first digital photograph inputting to said satellite device an object information capture;
wherein said object information capture is said first digital photograph;
transmitting, by said satellite device, said digital photograph to said central device;
extracting one or more features, by said central device, from said digital photograph;
determining, by said central device, a plurality of specifications of said extracted features;
comparing, by said central device, said plurality of specifications of said extracted features to at least one project goal of said one or more project goals;
determining, by said central device whether said plurality of specifications are deficient;
generating one or more work instructions and one or more impact forecasts if said plurality of specifications are deficient and transmitting said one or more impact forecasts and said one or more work instructions to said satellite device; and
generating a project completed message and a completed project data if said plurality of specifications are determined to be acceptable after comparison with said at least one project goal.

16. The method of monitoring and verifying construction of solar and energy storage projects of claim 15, further comprising:
outputting, by said satellite device, said one or more work instructions to said project owner; and
completing, by said project owner, said one or more work instructions on one or more project objects; and
wherein said one or more work instructions comprise taking a second digital photograph, such that a second digital photograph is inputted into said satellite device.

17. The method of monitoring and verifying construction of solar and energy storage projects of claim 16, further comprising:
processing, by said central device, said project completed message;
transmitting, by said central device, said project completed message to said satellite device;
outputting, by said satellite device, said project completed message; and
updating, by said central device, said plurality of project information, said plurality of equipment information, and said one or more action recommendations with said completed project data.

18. A method of monitoring and verifying construction of solar and energy storage projects comprising:
providing a central device;
providing a satellite device, which comprises a digital camera and a communication devices module;
wherein said central device and said satellite device are in communication with each other;
prompting a user to take a digital photograph of at least a portion of a solar and energy storage project with said satellite device;
taking said digital photograph with said satellite device;
transmitting said digital photograph to said central device;
determining by said central device whether said digital photograph shows that said at least a portion of a solar and energy storage project has been constructed correctly;
generating one or more work instructions and one or more impact forecasts if constructed incorrectly;
transmitting said one or more impact forecasts and said one or more work instructions to said satellite device; and
generating a project completed message and a completed project data if constructed correctly.

19. The method of monitoring and verifying construction of solar and energy storage projects of claim 18, wherein said one or more work instructions comprise prompting said user to take a second digital photograph of said at least a portion of said solar and energy storage project with said satellite device after said one or more work instructions are completed.

20. A method of monitoring and verifying construction of solar and energy storage projects comprising:
providing a central device;
providing one or more satellite devices, each of which comprises a digital camera and a communication devices module;
providing a plurality of project objects at a project site;
wherein said central device comprises a server device and one or more edge devices;
wherein said central device and said one or more satellite devices are in communication with each other;
entering, by a project owner, into said one or more satellite devices a project type, one or more project goals, a plurality of project information, a plurality of equipment information, and one or more action recommendations;
transmitting, by said one or more satellite devices, said project type, said one or more project goals, said plurality of project information, said plurality of equipment information, and said one or more action recommendations to said central device;
generating, by said central device, an information capture instruction based on said project type, said one or more project goals, said plurality of project information, said plurality of equipment information, and said one or more action recommendations; and
storing, by said central device, said information capture instruction;
receiving, by said one or more satellite devices, said information capture instruction;
storing, by said one or more satellite devices, said information capture instruction;
providing, by said one or more satellite devices, said information capture instruction to said project owner;
inputting to said one or more satellite devices an object information capture;
wherein said object information capture is a digital photograph;
classifying, by said one or more satellite devices, said object information capture;
preprocessing, by said one or more satellite devices, said object information capture;
transmitting, by said one or more satellite devices, said classified and preprocessed object information capture to said central device;
storing, by said central device, said classified and preprocessed object information capture;
final processing, by said central device, said classified and preprocessed object information capture;
storing, by said central device, said final processed object information capture;
extracting one or more features, by said central device, from said final processed object information capture;
storing, by said central device, said extracted features;
determining, by said central device, a plurality of specifications of said extracted features;
storing, by said central device, said plurality of specifications of said extracted features;
comparing, by said central device, said plurality of specifications of said extracted features to a project goal;
determining, by said central device, whether said plurality of specifications are deficient;
generating one or more work instructions and one or more impact forecasts if said plurality of specifications are deficient and transmitting said one or more impact forecasts and said one or more work instructions to said one or more satellite devices;
storing, by said one or more satellite devices, said one or more work instructions;
outputting, by said one or more satellite devices, said one or more work instructions to said project owner;
completing, by said project owner, said one or more work instructions on said project objects;
wherein said one or more work instructions comprise a second information capture instruction, such that a second object information capture is inputted into said one or more satellite devices after said one or more work instructions are completed;
generating a project completed message and a completed project data if said plurality of specifications are determined to be acceptable after comparison with said project goal;
processing, by said central device, said project completed message;
transmitting said project completed message to said one or more satellite devices; transmitting said project completed message to a project owner system;
outputting, by said one or more satellite devices, said project completed message; storing, by said central device, a completed project data; and
updating, by said central device, said plurality of project information, said plurality of equipment information, and said one or more action recommendations with said completed project data.
